(19) United States
(12) Patent Application Publication
(10) Pub. No.: US 2015/0186893 A1
(43) Pub. Date: Jul. 2, 2015

(54) INFORMATION TECHNOLOGY INCIDENT NOTIFICATION

(71) Applicant: Bank of America Corporation, Charlotte, NC (US)

(72) Inventors: Renee M. Kimble, Valatie, NY (US); Keith Cormier, Charlotte, NC (US)

(73) Assignee: Bank of America Corporation, Charlotte, NC (US)

(21) Appl. No.: 14/144,935

(22) Filed: Dec. 31, 2013

(51) Int. Cl. G06Q 30/00

(52) U.S. Cl. CPC G06Q 30/016

(57) ABSTRACT

A request to report an information technology incident of a financial institution may be received from a user device. A user interface comprising a plurality of selectable options and a plurality of questions regarding the information technology incident of the financial institution may be generated and communicated to the user device. The user interface may be configured to, based on a line of business of the financial institution selected using a first selectable option and a state of the information technology incident of the financial institution selected using a second selectable option, display a first portion of the plurality of questions regarding the information technology incident of the financial institution and hide a second portion of the plurality of questions regarding the information technology incident of the financial institution.

### BACKGROUND

Information technology is playing an ever more prominent role in modern organizations. For example, many businesses, such as financial institutions, utilize information technology to not only manage internal business processes, but also to interface with customers and partner institutions. Thus, an information technology incident (e.g., a disruption or degradation in service) may have far-ranging implications (e.g., ranging from a minor inconvenience for a customer, vendor, or associate to an interruption affecting a business-critical system or service). The potentiality for such far-ranging implications, especially when combined with the frequency and volume of information technology incidents within a large organization, can often make it difficult to identify and prioritize information technology incidents, and/or notify relevant information technology professionals or affected stakeholders. Accordingly, a need exists for information technology incident notification.

### SUMMARY

The following presents a simplified summary in order to provide a basic understanding of some aspects of the disclosure. This summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In accordance with one or more embodiments, a request to report an information technology incident of a financial institution may be received from a user device. Responsive to receiving the request to report the information technology incident of the financial institution, a user interface comprising a plurality of selectable options and a plurality of questions regarding the information technology incident of the financial institution may be generated and communicated to the user device. A first selectable option of the plurality of selectable options may comprise a plurality of options corresponding to lines of business of the financial institution. A second selectable option of the plurality of selectable options may comprise a plurality of options corresponding to states of the information technology incident of the financial institution. The user interface may be configured to, based on a line of business of the financial institution selected using the first selectable option and a state of the information technology incident of the financial institution selected using the second selectable option, display a first portion of the plurality of questions regarding the information technology incident of the financial institution and hide a second portion of the plurality of questions regarding the information technology incident of the financial institution.

In some embodiments, a plurality of responses input via the user interface comprising the plurality of selectable options and the plurality of questions regarding the information technology incident of the financial institution may be received from the user device. Each response of the plurality of responses may correspond to a question of the plurality of questions regarding the information technology incident of the financial institution that is in the first portion of the plurality of questions regarding the information technology incident of the financial institution. The plurality of responses input via the user interface comprising the plurality of selectable options and the plurality of questions regarding the information technology incident of the financial institution may be utilized to create an information technology incident record for the information technology incident of the financial institution, and the information technology incident record for the information technology incident of the financial institution may be stored in a memory.

In some embodiments, a plurality of individuals associated with the financial institution that should be notified of the information technology incident of the financial institution may be identified based on the line of business of the financial institution selected using the first selectable option. A notification regarding the information technology incident of the financial institution may be generated based on the plurality of responses input via the user interface comprising the plurality of selectable options and the plurality of questions regarding the information technology incident of the financial institution. The notification regarding the information technology incident of the financial institution may be communicated to one or more user devices associated with the plurality of individuals associated with the financial institution that should be notified of the information technology incident of the financial institution.

In some embodiments, generating the notification regarding the information technology incident of the financial institution may comprise generating a notification regarding the information technology incident of the financial institution that comprises information indicating the state of the information technology incident of the financial institution selected using the second selectable option. Additionally or alternatively, generating the notification regarding the information technology incident of the financial institution may comprise generating a notification regarding the information technology incident of the financial institution that comprises information from one or more responses of the plurality of responses input via the user interface comprising the plurality of selectable options and the plurality of questions regarding the information technology incident of the financial institution.

In some embodiments, generating the notification regarding the information technology incident of the financial institution may comprise determining, based on the state of the information technology incident of the financial institution selected using the second selectable option, a level of specificity for the notification regarding the information technology incident of the financial institution, and generating a notification regarding the information technology incident of the financial institution having the level of specificity for the notification regarding the information technology incident of the financial institution.

In some embodiments, identifying the plurality of individuals associated with the financial institution that should be notified of the information technology incident of the financial institution may comprise identifying, based on the state of the information technology incident of the financial institution selected using the second selectable option, one or more individuals of the plurality of individuals associated with the financial institution that should be notified of the information technology incident of the financial institution. Additionally or alternatively, identifying the plurality of individuals associated with the financial institution that should be notified of the information technology incident of the financial institution may comprise identifying, based on information from one or more responses of the plurality of responses input via the user interface comprising the plurality of selectable options and the plurality of questions regarding the information technology incident of the financial institution, one or more individuals of the plurality of individuals associated with the financial institution that should be notified of the information technology incident of the financial institution.

In some embodiments, an email message comprising the notification regarding the information technology incident of the financial institution, a short message service (SMS) message comprising the notification regarding the information technology incident of the financial institution, a multimedia messaging service (MMS) message comprising the notification regarding the information technology incident of the financial institution, and/or a message comprising the notification regarding the information technology incident of the financial institution that is configured for an information technology incident mobile application of the financial institution may be generated. In such embodiments, communicating the notification regarding the information technology incident of the financial institution may comprise communicating, to at least one of the one or more user devices associated with the plurality of individuals associated with the financial institution that should be notified of the information technology incident of the financial institution, the email message comprising the notification regarding the information technology incident of the financial institution, the SMS message comprising the notification regarding the information technology incident of the financial institution, the MMS message comprising the notification regarding the information technology incident of the financial institution, and/or the message comprising the notification regarding the information technology incident of the financial institution that is configured for the information technology incident mobile application of the financial institution.

In some embodiments, generating the notification regarding the information technology incident of the financial institution may comprise generating a notification regarding the information technology incident of the financial institution that comprises a link to an interface associated with the information technology incident record for the information technology incident of the financial institution. A message indicating that the link to the interface associated with the information technology incident record for the information technology incident of the financial institution has been invoked may be received from a user device of the one or more user devices associated with the plurality of individuals associated with the financial institution that should be notified of the information technology incident of the financial institution. Responsive to receiving the message indicating that the link to the interface associated with the information technology incident record for the information technology incident of the financial institution has been invoked, a user interface comprising the state of the information technology incident of the financial institution selected using the second selectable option and a selectable option for updating the state of the information technology incident of the financial institution may be generated and communicated to the user device of the one or more user devices associated with the plurality of individuals associated with the financial institution that should be notified of the information technology incident of the financial institution.

In some embodiments, a message comprising information indicating an updated state of the information technology incident of the financial institution selected using the selectable option for updating the state of the information technology incident of the financial institution may be received from the user device of the one or more user devices associated with the plurality of individuals associated with the financial institution that should be notified of the information technology incident of the financial institution. The information technology incident record for the information technology incident of the financial institution may be altered to reflect the updated state of the information technology incident of the financial institution selected using the selectable option for updating the state of the information technology incident of the financial institution.

In some embodiments, a portion of the plurality of individuals associated with the financial institution that should be notified of the information technology incident of the financial institution that should also be notified of the updated state of the information technology incident of the financial institution selected using the selectable option for updating the state of the information technology incident of the financial institution may be identified based on the updated state of the information technology incident of the financial institution selected using the selectable option for updating the state of the information technology incident of the financial institution. An update notification regarding the information technology incident of the financial institution that comprises the updated state of the information technology incident of the financial institution selected using the selectable option for updating the state of the information technology incident of the financial institution may be generated and communicated to one or more user devices associated with the portion of the plurality of individuals associated with the financial institution that should be notified of the information technology incident of the financial institution that should also be notified of the updated state of the information technology incident of the financial institution selected using the selectable option for updating the state of the information technology incident of the financial institution.

In some embodiments, the plurality of responses input via the user interface comprising the plurality of selectable options and the plurality of questions regarding the information technology incident of the financial institution may be utilized to generate a message comprising information configured for a system of record for information technology incidents of the financial institution. The information configured for the system of record for information technology incidents of the financial institution may utilize a format that differs from a format of the information technology incident record for the information technology incident of the financial institution.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for information technology incident notification in accordance with one or more example embodiments;

FIGS. 4A, 4B, 4C, 4D, 4E, and 4F depict an illustrative event sequence for information technology incident notification in accordance with one or more example embodiments;

FIG. 5 depicts an example user interface for information technology incident notification in accordance with one or more example embodiments; and

FIG. 6 depicts an illustrative method for information technology incident notification in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

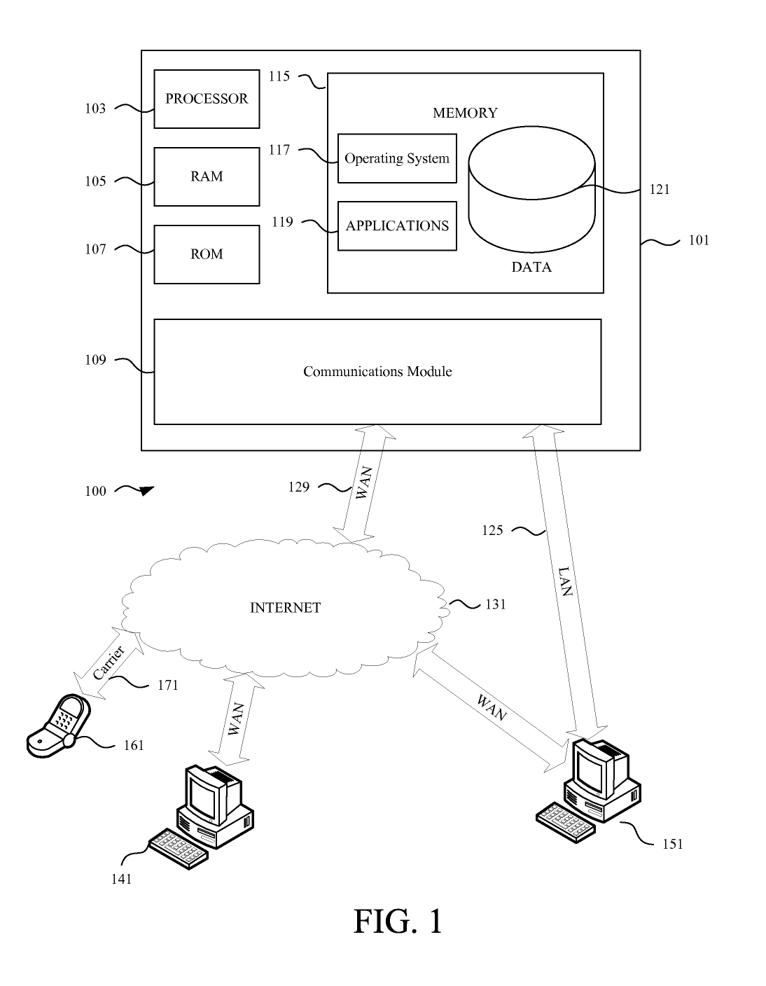

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

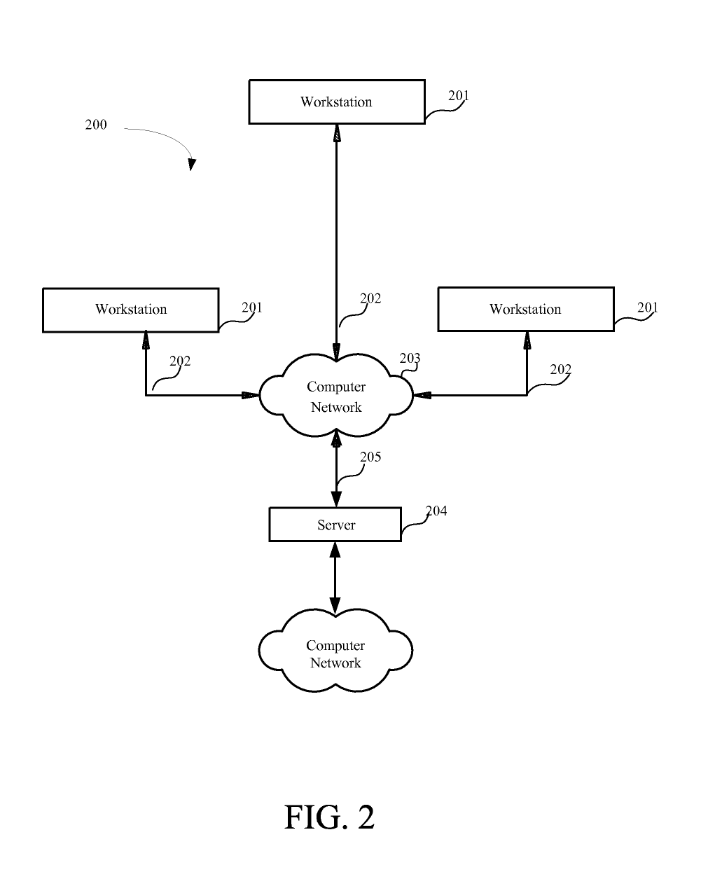

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

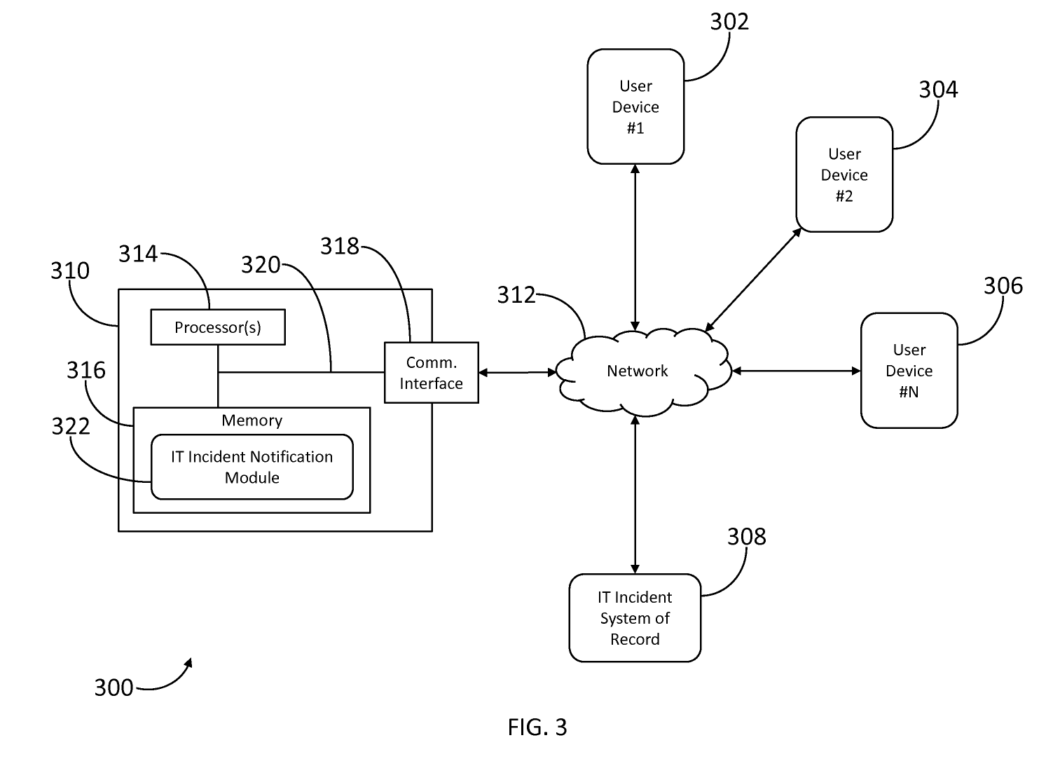

FIG. 3 depicts an illustrative computing environment for information technology incident notification in accordance with one or more example embodiments. Referring to FIG. 3, computing environment 300 may include one or more computing devices associated with an organization (e.g., a financial institution, corporation, government entity, university, or the like). For example, computing environment 300 may include user devices 302, 304, and 306. User devices 302, 304, and 306 may be any type of computing device capable of receiving a user interface, receiving input via the user interface, and communicating the received input to one or more other computing devices. For example, user device 302, 304, and/or 306 may be a desktop computer, laptop computer, tablet computer, smart phone, or the like. Computing environment 300 may also include information technology incident system of record 308, computing platform 310, and network 312. As will be described in greater detail below, information technology incident system of record 308 may be any type of computing device (e.g., desktop computer, laptop computer, server, set of virtual and/or cloud resources, or the like) that maintains records for information technology incidents of an organization (e.g., a financial institution or other type of entity). Network 312 may interconnect one or more of user devices 302, 304, and 306, information technology incident system of record 308, and/or computing platform 310. Network 312 may include one or more sub-networks (e.g., LANs, WANs, or the like).

Computing platform 310 may include one or more processor(s) 314, memory 316, communication interface 318, and data bus 320. Data bus 320 may interconnect processor(s) 314, memory 316, and/or communication interface 318. Communication interface 318 may be a network interface configured to support communication between computing platform 310 and network 312, or one or more sub-networks thereof. Memory 316 may include one or more program modules comprising instructions that when executed by processor(s) 314 cause computing platform 310 to perform one or more functions described herein. For example, memory 316 may include information technology incident notification module 322. As will be described in greater detail below, information technology incident notification module 322 may comprise instructions that when executed by processor(s) 314 cause computing platform 310 to receive (e.g., via communication interface 318) a request to report an information technology incident of a financial institution from a user device (e.g., user device 302). Responsive to receiving the request to report the information technology incident of the financial institution, the instructions may further cause computing platform 310 to generate a user interface comprising a plurality of selectable options and a plurality of questions regarding the information technology incident of the financial institution, and to communicate (e.g., via communication interface 318) the user interface comprising the plurality of selectable options and the plurality of questions regarding the information technology incident of the financial institution to the user device (e.g., user device 302).

As will be described in greater detail below, a first selectable option of the plurality of selectable options may comprise a plurality of options corresponding to lines of business of the financial institution, and a second selectable option of the plurality of selectable options may comprise a plurality of options corresponding to states of the information technology incident of the financial institution. The user interface may be configured to, based on a line of business of the financial institution selected using the first selectable option and a state of the information technology incident of the financial institution selected using the second selectable option, display a first portion of the plurality of questions regarding the information technology incident of the financial institution and hide a second portion of the plurality of questions regarding the information technology incident of the financial institution.

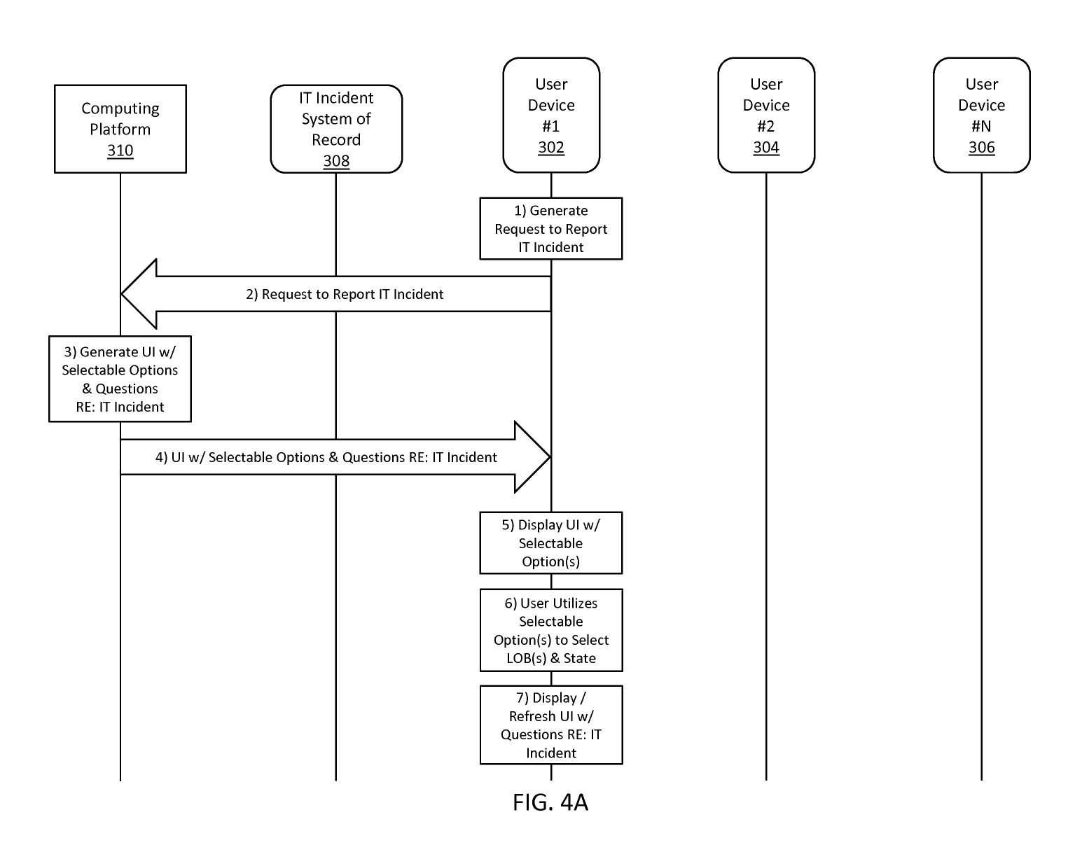

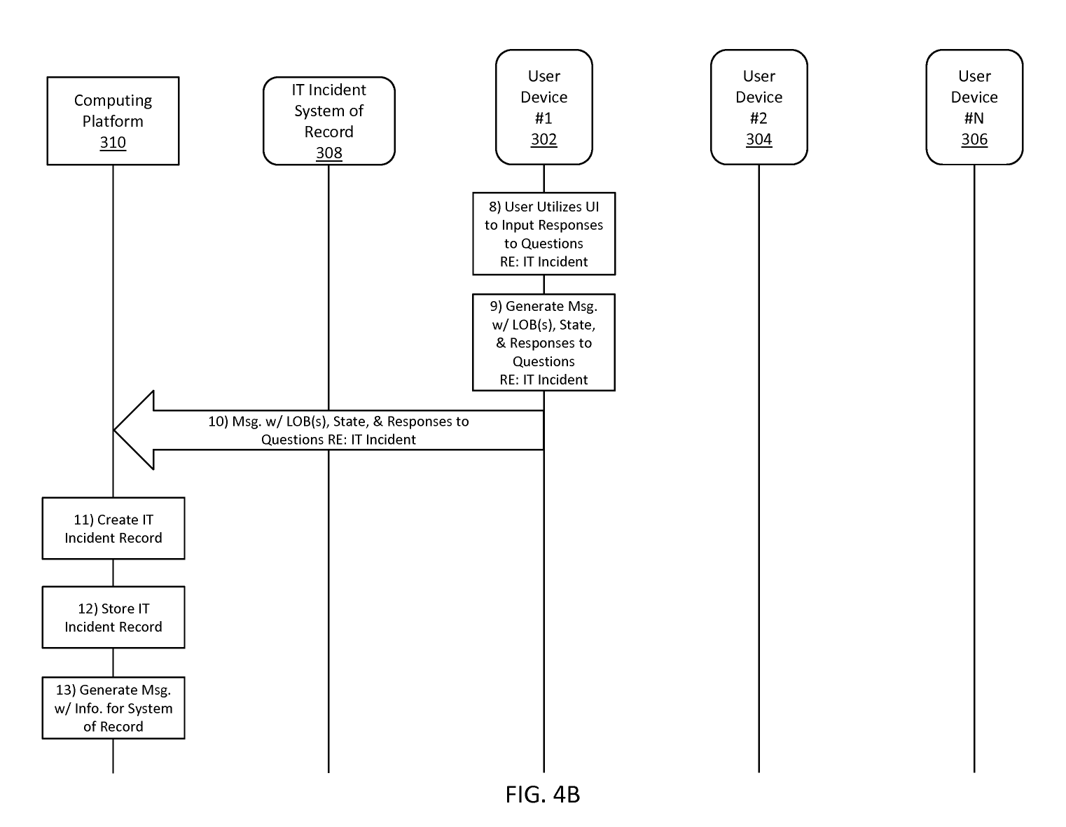

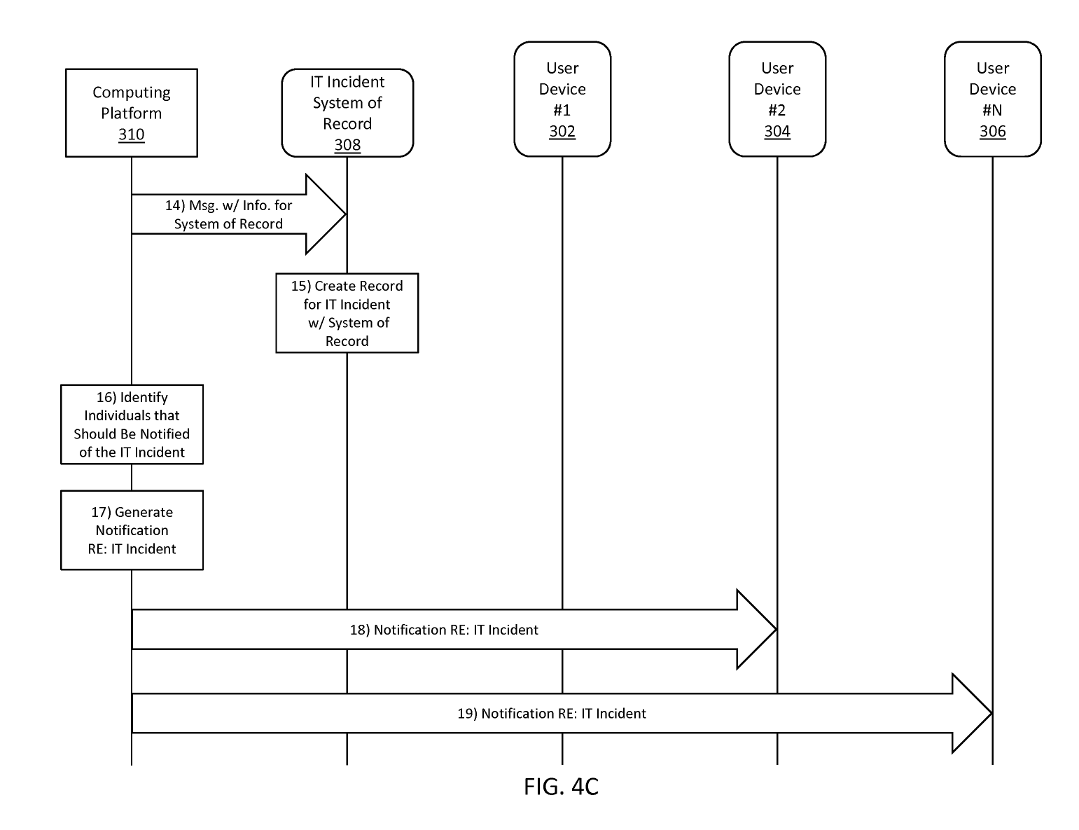

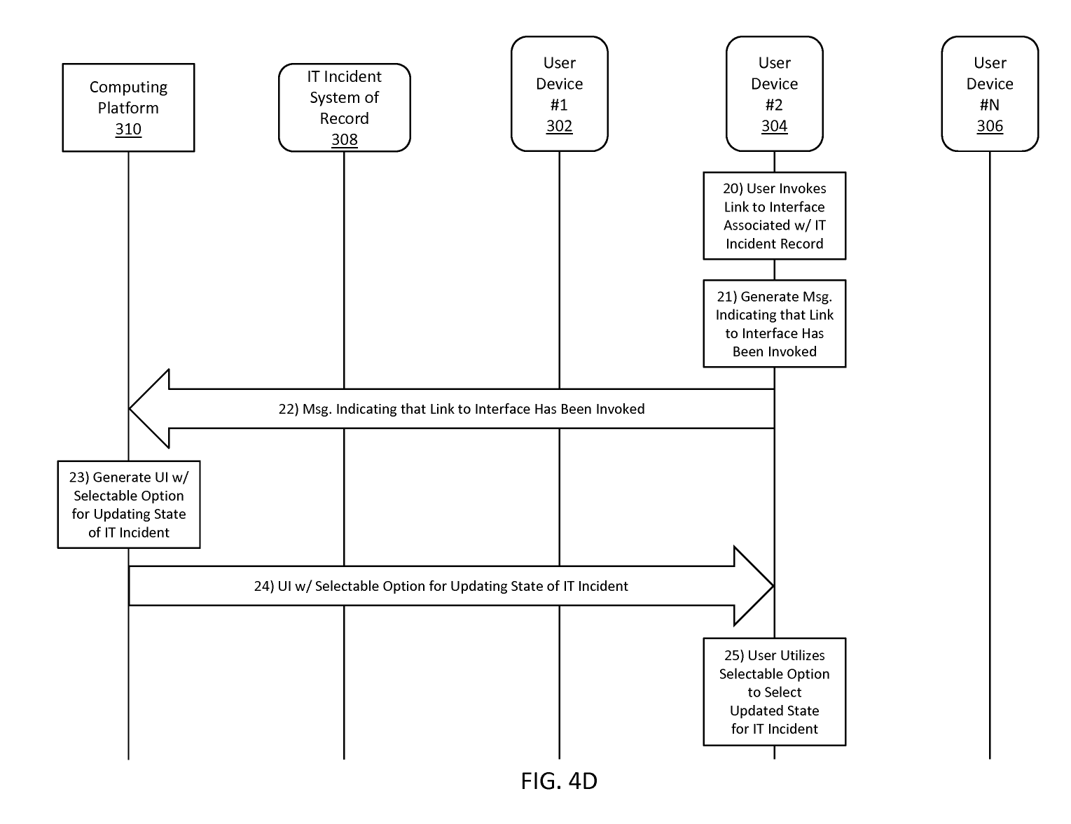

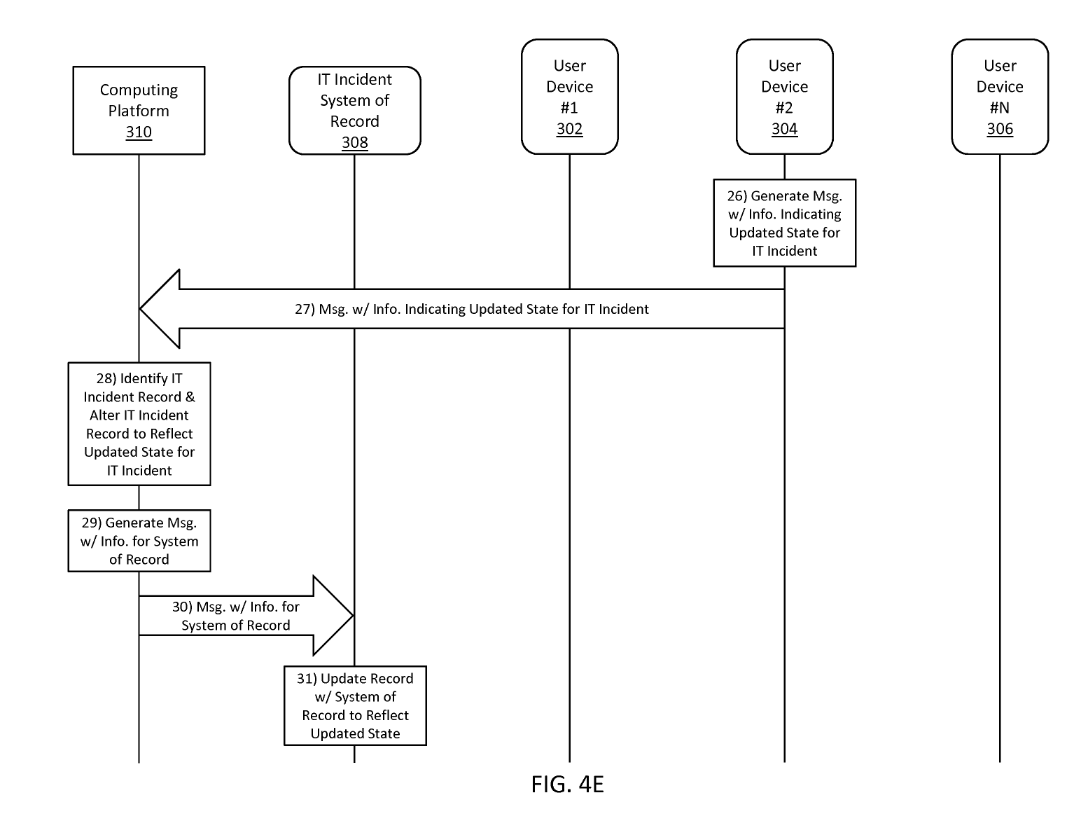

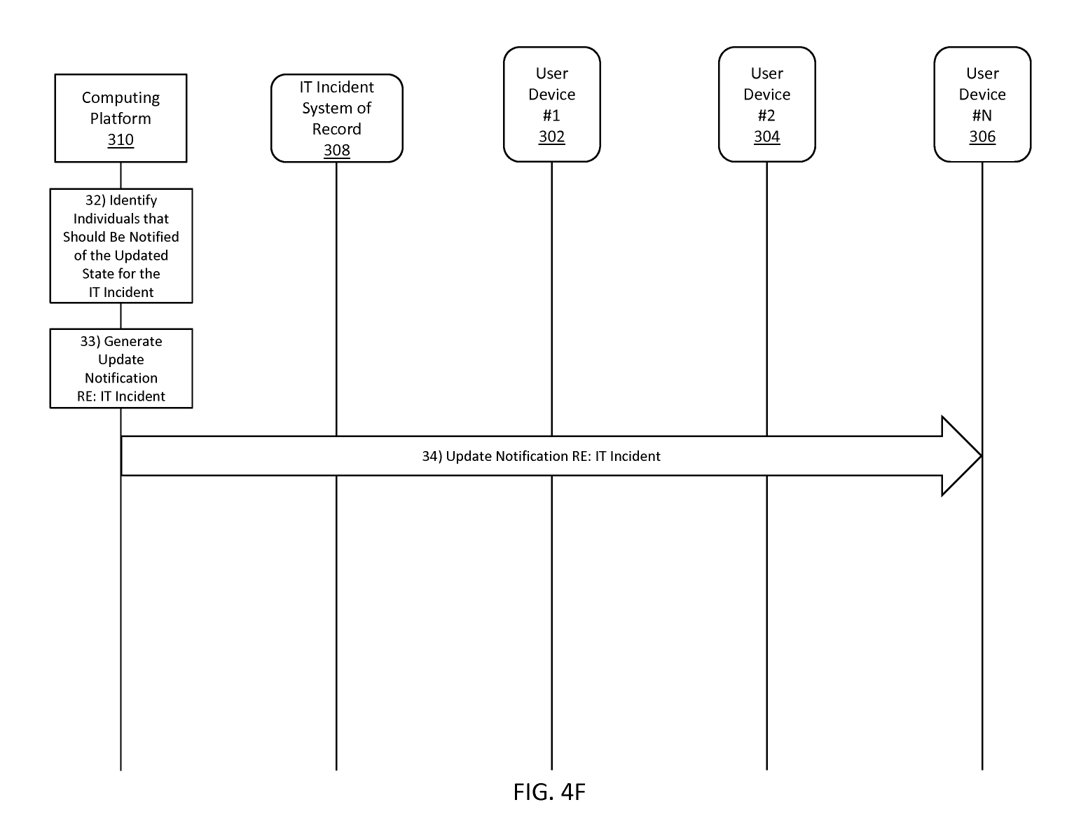

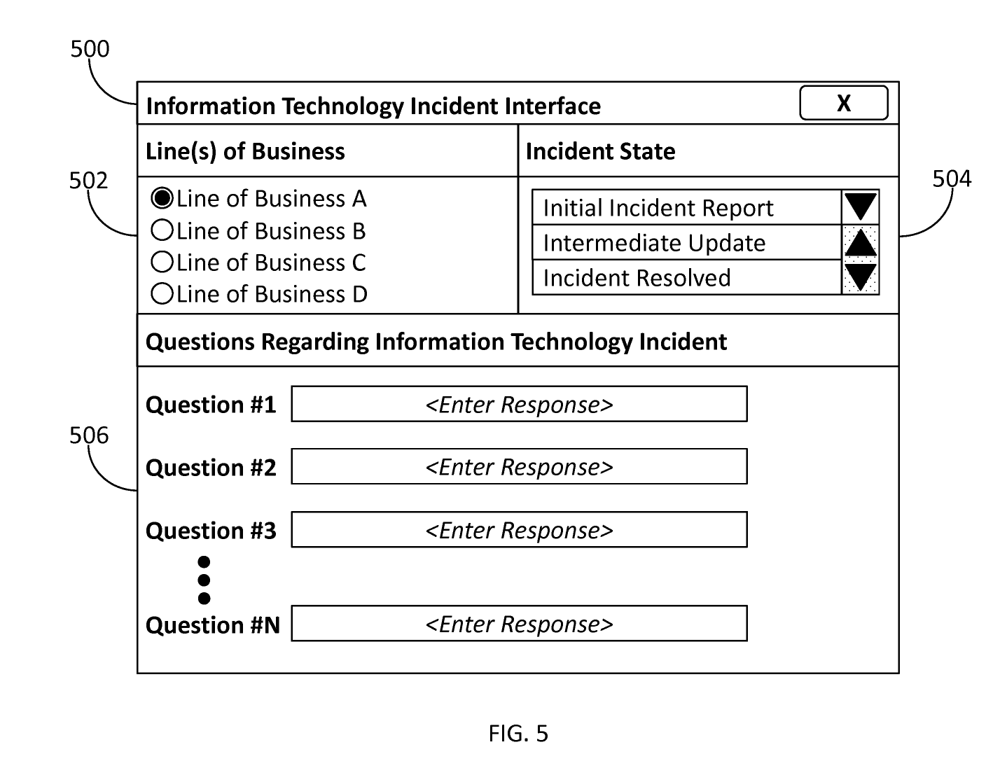

FIGS. 4A, 4B, 4C, 4D, 4E, and 4F depict an illustrative event sequence for information technology incident notification in accordance with one or more example embodiments. Referring to FIG. 4A, at step 1, user device 302 may generate a request to report an information technology incident of a financial institution. For example, a user of user device 302 (e.g., an associate of the financial institution) may have become aware of an information technology incident of the financial institution (e.g., interruption in service, degradation of service, or other similar event) and may utilize user device 302 to generate a request to report an information technology incident of the financial institution (e.g., via an application executing on user device 302, via a web application utilizing a web browser executing on user device 302, via an email generated using an email application executing on user device 302, or the like). At step 2, user device 302 may communicate the request to report the information technology incident of the financial institution to computing platform 310. For example, user device 302 may communicate the request to report the information technology incident of the financial institution to computing platform 310. At step 3, responsive to receiving the request to report the information technology incident of the financial institution (e.g., via communication interface 318), computing platform 310 may generate a user interface comprising a plurality of selectable options and a plurality of questions regarding the information technology incident of the financial institution. For example, referring to FIG. 5, computing platform 310 may generate a user interface similar to user interface 500. A first selectable option of the plurality of selectable options may comprise a plurality of options corresponding to lines of business of the financial institution. For example, selectable option(s) 502 may include a listing of one or more lines of business of the financial institution (e.g., “Line of Business A,” “Line of Business B,” “Line of Business C,” “Line of Business D,” and the like). A second selectable option of the plurality of selectable options may comprise a plurality of options corresponding to states of the information technology incident of the financial institution. For example, selectable option(s) 504 may include a listing of one or more possible states of the information technology incident of the financial institution (e.g., “Initial Incident Report,” “Intermediate Update,” “Incident Resolved,” and the like). User interface 500 may also include question region 506, which may include one or more questions regarding the information technology incident of the financial institution (e.g., “Question #1,” “Question #2,” and “Question #3” through “Question #N”) and/or one or more user interface elements for providing a response to the one or more questions regarding the information technology incident of the financial institution.

As will be described in greater detail below, the user interface may be configured to, based on a line of business of the financial institution selected using the first selectable option and a state of the information technology incident of the financial institution selected using the second selectable option, display a first portion of the plurality of questions regarding the information technology incident of the financial institution and hide a second portion of the plurality of questions regarding the information technology incident of the financial institution. For example, user interface 500 may be configured to, based on a line of business of the financial institution selected using one or more of selectable option(s) 502 (e.g., “Line of Business A”) and a state of the information technology incident of the financial institution selected using one or more of selectable option(s) 504 (e.g., “Initial Incident Report”), display a first portion of the plurality of questions regarding the information technology incident of the financial institution (e.g., “Question #1” and “Question #2”) and hide a second portion of the plurality of questions regarding the information technology incident of the financial institution (e.g., “Question #3” through “Question #N”). Returning to FIG. 4A, at step 4, computing platform 310 may communicate the user interface comprising the plurality of selectable options and the plurality of questions regarding the information technology incident of the financial institution to user device 302. For example, computing platform 310 may communicate (e.g., via communication interface 318) user interface 500 to user device 302.

At step 5, user device 302 may receive the user interface comprising the plurality of selectable options and the plurality of questions regarding the information technology incident of the financial institution, and may display the user interface comprising the plurality of selectable options and the plurality of questions regarding the information technology incident of the financial institution or a portion thereof. For example, user device 302 may receive user interface 500 and may display selectable option(s) 502 and selectable option(s) 504. At step 6, a user of user device 302 may utilize user interface 500 to select one or more lines of business of the financial institution that are impacted or affected by the information technology incident of the financial institution and a state of the information technology incident of the financial institution. For example, a user of user device 302 may utilize one or more of selectable option(s) 502 to select “Line of Business A” as impacted or affected by the information technology incident of the financial institution and may utilize one or more of selectable option(s) 504 to select “Initial Incident Report” as a state of the information technology incident of the financial institution. At step 7, user device 302 may display, redisplay, regenerate, refresh, re-render, or the like user interface 500 to, based on the selected line(s) of business and the selected state of the information technology incident of the financial institution, display a first portion of the plurality of questions regarding the information technology incident of the financial institution and hide a second portion of the plurality of questions regarding the information technology incident of the financial institution. For example, user device 302 may, based on the selection of “Line of Business A” and “Initial Incident Report,” refresh user interface 500, or a portion thereof, to display “Question #1” and “Question #2” and hide (or fail to visibly display) “Question #3” through “Question #N” (e.g., “Question #1” and “Question #2” may be relevant to an information technology incident that impacts or affects “Line of Business A” and is at a state of “Initial Incident Report” and thus may be displayed, while “Question #3” through “Question #N” may be irrelevant to an information technology incident that impacts or affects “Line of Business A” and is at a state of “Initial Incident Report” and thus may be hidden from view).

Referring to FIG. 4B, at step 8, a user of user device 302 may utilize the user interface comprising the plurality of selectable options and the plurality of questions regarding the information technology incident of the financial institution to provide responses to one or more of the plurality of questions regarding the information technology incident of the financial institution. For example, a user of user device 302 may utilize user interface 500 to provide responses to “Question #1” and “Question #2” (e.g., the displayed questions). At step 9, user device 302 may generate a message comprising the selected line(s) of business, the selected state of the information technology incident of the financial institution, and the provided responses to the one or more of the plurality of questions regarding the information technology incident of the financial institution, and, at step 10, may communicate the message comprising the selected line(s) of business, the selected state of the information technology incident of the financial institution, and the provided responses to the one or more of the plurality of questions regarding the information technology incident of the financial institution to computing platform 310 (e.g., via network 312). For example, user device 302 may generate a message comprising information identifying the selection of “Line of Business A” and “Initial Incident Report,” as well as the inputted responses to “Question #1” and “Question #2” (e.g., the displayed questions), and may communicate the message comprising the information identifying the selection of “Line of Business A” and “Initial Incident Report,” and the inputted responses to “Question #1” and “Question #2” to computing platform 310. Computing platform 310 may receive (e.g., via communication interface 318) the message comprising the selected line(s) of business, the selected state of the information technology incident of the financial institution, and the provided responses to the one or more of the plurality of questions regarding the information technology incident of the financial institution, and, at step 11, may utilize the selected line(s) of business, the selected state of the information technology incident of the financial institution, and the provided responses to the one or more of the plurality of questions regarding the information technology incident of the financial institution to create an information technology incident record for the information technology incident of the financial institution, which may, at step 12, be stored (e.g., in memory 316). For example, computing platform 310 may receive the message comprising the information identifying the selection of “Line of Business A” and “Initial Incident Report,” and the inputted responses to “Question #1” and “Question #2,” and may utilize the information identifying the selection of “Line of Business A” and “Initial Incident Report,” and the inputted responses to “Question #1” and “Question #2,” to create an information technology incident record for the information technology incident of the financial institution, and may store the information technology incident record for the information technology incident of the financial institution in memory 316.

At step 13, computing platform 310 may utilize the selected line(s) of business, the selected state of the information technology incident of the financial institution, and the provided responses to the one or more of the plurality of questions regarding the information technology incident of the financial institution to generate a message comprising information configured for a system of record for information technology incidents of the financial institution (e.g., information technology incident system of record 308). For example, computing platform 310 may utilize the information identifying the selection of “Line of Business A” and “Initial Incident Report,” and the inputted responses to “Question #1” and “Question #2,” to generate a message comprising information configured for information technology incident system of record 308. In some embodiments, the information configured for the system of record for information technology incidents of the financial institution may utilize a format that differs from a format of the information technology incident record for the information technology incident of the financial institution (e.g., the information technology incident record for the information technology incident of the financial institution created in step 11), and computing platform 310 may be configured to reformat the selected line(s) of business, the selected state of the information technology incident of the financial institution, and the provided responses to the one or more of the plurality of questions regarding the information technology incident of the financial institution to be compatible with the differing format utilized by the system of record for information technology incidents of the financial institution. For example, information technology incident system of record 308 may utilize records having a format that comprises different (e.g., more, fewer, or differently designated) states of information technology incidents of the financial institution, and computing platform 310 may be configured to select an analogous or corresponding state designation utilized by information technology incident system of record 308. Additionally or alternatively, information technology incident system of record 308 may utilize records having different (e.g., more, fewer, or differently designated) fields for information contained in the responses to the one or more of the plurality of questions regarding the information technology incident of the financial institution, and computing platform 310 may be configured to reparse and/or reorganize information contained in the responses to the one or more of the plurality of questions regarding the information technology incident of the financial institution to be compatible with the differing fields utilized by information technology incident system of record 308.

Referring to FIG. 4C, at step 14, computing platform 310 may communicate (e.g., via communication interface 318) the message comprising information configured for information technology incident system of record 308 to information technology incident system of record 308, and, at step 15, information technology incident system of record 308 may utilize the information configured for information technology incident system of record 308 to create a record for the information technology incident of the financial institution. For example, computing platform 310 may communicate the message comprising the reformatted information generated from the information identifying the selection of “Line of Business A” and “Initial Incident Report,” and the inputted responses to “Question #1” and “Question #2” to information technology incident system of record 308, which may utilize the reformatted information generated from the information identifying the selection of “Line of Business A” and “Initial Incident Report,” and the inputted responses to “Question #1” and “Question #2” to create a record for the information technology incident of the financial institution.

At step 16, computing platform 310 may identify a plurality of individuals associated with the financial institution (and/or computing devices associated with such individuals) that should be notified of the information technology incident of the financial institution. For example, computing platform 310 may identify individuals associated with user devices 304 and 306 as individuals associated with the financial institution that should be notified of the information technology incident of the financial institution. In some embodiments, one or more of the plurality of individuals associated with the financial institution (and/or one or more computing devices associated with such individuals) that should be notified of the information technology incident of the financial institution may be identified based on the line of business of the financial institution selected using the first selectable option. For example, user device 304 and/or 306 (and/or individuals associated therewith) may be associated with associates of the financial institution that are stakeholders (e.g., executives, managers, or like) who will be impacted or affected by an information technology incident that impacts or affects “Line of Business A.” Additionally or alternatively, one or more of the plurality of individuals associated with the financial institution (and/or one or more computing devices associated with such individuals) that should be notified of the information technology incident of the financial institution may be identified based on the state of the information technology incident of the financial institution selected using the second selectable option and/or one or more responses of the plurality of responses input via the user interface comprising the plurality of selectable options and the plurality of questions regarding the information technology incident of the financial institution. For example, user device 304 and/or 306 (and/or individuals associated therewith) may be associated with associates of the financial institution that should be notified of an “Initial Incident Report” for an information technology incident of the financial institution and/or one or more of the inputted responses to “Question #1” and/or “Question #2” may comprise information (e.g., information concerning the nature of the information technology incident of the financial institution, or the like) from which an associate of the financial institution that should be notified of the information technology incident of the financial institution may be identified (e.g., an information technology associate of the financial institution who specializes in an aspect of information technology related to the nature of the information technology incident of the financial institution, or the like).

At step 17, computing platform 310 may generate a notification regarding the information technology incident of the financial institution based on the plurality of responses input via the user interface comprising the plurality of selectable options and the plurality of questions regarding the information technology incident of the financial institution. For example, computing platform 310 may generate a notification regarding the information technology incident of the financial institution based on the plurality of responses input via user interface 500. In some embodiments, generating the notification regarding the information technology incident of the financial institution may comprise generating a notification regarding the information technology incident of the financial institution that comprises information indicating the state of the information technology incident of the financial institution selected using the second selectable option. For example, computing platform 310 may generate a notification regarding the information technology incident of the financial institution that indicates that the notification is an “Initial Incident Report” for the information technology incident of the financial institution. Additionally or alternatively, generating the notification regarding the information technology incident of the financial institution may comprise generating a notification regarding the information technology incident of the financial institution that comprises information from one or more responses of the plurality of responses input via the user interface comprising the plurality of selectable options and the plurality of questions regarding the information technology incident of the financial institution. For example, computing platform 310 may generate a notification regarding the information technology incident of the financial institution that includes the responses (or portions thereof) to “Question #1” and/or “Question #2” input via user interface 500.

In some embodiments, generating the notification regarding the information technology incident of the financial institution may comprise determining, based on the state of the information technology incident of the financial institution selected using the second selectable option, a level of specificity for the notification regarding the information technology incident of the financial institution, and generating a notification regarding the information technology incident of the financial institution having the level of specificity for the notification regarding the information technology incident of the financial institution. For example, computing platform 310 may determine, based on the selection indicating that the state of the information technology incident is an “Initial Incident Report” for the information technology incident of the financial institution, that a greater level of specificity should be used for the notification regarding the information technology incident of the financial institution (e.g., as opposed to if the selection had indicated that the state of the information technology incident was an “Intermediate Update” or “Incident Resolved”), and computing platform 310 may generate a notification regarding the information technology incident of the financial institution having the greater level of specificity.

As will be described in greater detail below, in some embodiments, generating the notification regarding the information technology incident of the financial institution may comprise generating a notification regarding the information technology incident of the financial institution that comprises a link to an interface associated with the information technology incident record for the information technology incident of the financial institution. For example, computing platform 310 may generate a notification regarding the information technology incident of the financial institution that comprises a link (e.g., a hyperlink, user interface element, or the like) to an interface associated with the information technology incident record for the information technology incident of the financial institution created in step 11 above.

At steps 18 and 19, the notification regarding the information technology incident of the financial institution may be communicated to one or more user devices associated with the identified plurality of individuals associated with the financial institution that should be notified of the information technology incident of the financial institution (e.g., user devices 304 and 306). In some embodiments, computing platform 310 may be configured to generate an email message comprising the notification regarding the information technology incident of the financial institution, an SMS message comprising the notification regarding the information technology incident of the financial institution, an MMS message comprising the notification regarding the information technology incident of the financial institution, and/or a message comprising the notification regarding the information technology incident of the financial institution that is configured for an information technology incident mobile application of the financial institution. In such embodiments, computing platform 310 may be configured to communicate the notification regarding the information technology incident of the financial institution to at least one of the one or more user devices associated with the plurality of individuals associated with the financial institution that should be notified of the information technology incident of the financial institution (e.g., user device 304 and/or 306), by communicating the email message comprising the notification regarding the information technology incident of the financial institution, the SMS message comprising the notification regarding the information technology incident of the financial institution, the MMS message comprising the notification regarding the information technology incident of the financial institution, and/or the message comprising the notification regarding the information technology incident of the financial institution that is configured for the information technology incident mobile application of the financial institution to the at least one of the one or more user devices associated with the plurality of individuals associated with the financial institution that should be notified of the information technology incident of the financial institution (e.g., user device 304 and/or 306).

As indicated above, in some embodiments, the notification regarding the information technology incident of the financial institution may comprise a link to an interface associated with the information technology incident record for the information technology incident of the financial institution. Referring to FIG. 4D, at step 20, a user of user device 304 may invoke the link to the interface associated with the information technology incident record for the information technology incident of the financial institution. Responsive to the user of user device 304 invoking the link to the interface associated with the information technology incident record for the information technology incident of the financial institution, at step 21, user device 304 may generate a message indicating that the link to the interface associated with the information technology incident record for the information technology incident of the financial institution has been invoked, and, at step 22, user device 304 may communicate the message indicating that the link to the interface associated with the information technology incident record for the information technology incident of the financial institution has been invoked to computing platform 310. Computing platform 310 may receive the message indicating that the link to the interface associated with the information technology incident record for the information technology incident of the financial institution has been invoked, and, responsive to receiving the message indicating that the link to the interface associated with the information technology incident record for the information technology incident of the financial institution has been invoked, at step 23, computing platform 310 may generate a user interface comprising the state of the information technology incident of the financial institution selected using the second selectable option (e.g., “Initial Incident Report”) and a selectable option for updating the state of the information technology incident of the financial institution (e.g., to “Intermediate Update” or “Incident Resolved”). At step 24, computing platform 310 may communicate the user interface comprising the state of the information technology incident of the financial institution selected using the second selectable option (e.g., “Initial Incident Report”) and the selectable option for updating the state of the information technology incident of the financial institution (e.g., to “Intermediate Update” or “Incident Resolved”) to user device 304. At step 25, a user of user device 304 may utilize the selectable option for updating the state of the information technology incident of the financial institution to select an updated state for the information technology incident of the financial institution (e.g., “Incident Resolved”).

Referring to FIG. 4E, at step 26, user device 304 may generate a message comprising information indicating the updated state of the information technology incident of the financial institution selected using the selectable option for updating the state of the information technology incident of the financial institution (e.g., “Incident Resolved”), and, at step 27, may communicate the message comprising the information indicating the updated state of the information technology incident of the financial institution selected using the selectable option for updating the state of the information technology incident of the financial institution to computing platform 310. At step 28, computing platform 310 may identify the information technology incident record for the information technology incident of the financial institution (e.g., the record created in step 11 above), and, may alter the information technology incident record for the information technology incident of the financial institution to reflect the updated state of the information technology incident of the financial institution selected using the selectable option for updating the state of the information technology incident of the financial institution (e.g., “Incident Resolved”). At step 29, computing platform 310 may generate a message comprising information configured for information technology incident system of record 308 that indicates the updated state of the information technology incident of the financial institution selected using the selectable option for updating the state of the information technology incident of the financial institution (e.g., “Incident Resolved”), and, at step 30, computing platform 310 may communicate the message comprising the information configured for information technology incident system of record 308 that indicates the updated state of the information technology incident of the financial institution selected using the selectable option for updating the state of the information technology incident of the financial institution (e.g., “Incident Resolved”). At step 31, information technology incident system of record 308 may receive the message comprising the information configured for information technology incident system of record 308 that indicates the updated state of the information technology incident of the financial institution selected using the selectable option for updating the state of the information technology incident of the financial institution (e.g., “Incident Resolved”) from computing platform 310, may identify the record for the information technology incident of the financial institution maintained by information technology incident system of record 308 (e.g., the record created in step 15 above) and may utilize the information configured for information technology incident system of record 308 that indicates the updated state of the information technology incident of the financial institution selected using the selectable option for updating the state of the information technology incident of the financial institution (e.g., “Incident Resolved”) to update the record to reflect the updated state of the information technology incident of the financial institution.

Referring to FIG. 4F, at step 32, computing platform 310 may identify a portion of the plurality of individuals associated with the financial institution that should be notified of the information technology incident of the financial institution that should also be notified of the updated state of the information technology incident of the financial institution (and/or computing devices associated with such individuals). In some embodiments, the portion of the plurality of individuals associated with the financial institution that should be notified of the information technology incident of the financial institution that should also be notified of the updated state of the information technology incident of the financial institution may be identified based on the updated state of the information technology incident of the financial institution. For example, computing platform 310 may identify user device 306 as being associated with an associate of the financial institution that should be notified when the information technology incident of the financial institution is resolved (e.g., based on the updated state of the information technology incident of the financial institution being “Incident Resolved”). At step 33, computing platform 310 may generate an update notification regarding the information technology incident of the financial institution that comprises the updated state of the information technology incident of the financial institution selected using the selectable option for updating the state of the information technology incident of the financial institution (e.g., “Incident Resolved”), and, at step 34, computing platform 310 may communicate the update notification to one or more user devices associated with the portion of the plurality of individuals associated with the financial institution that should be notified of the information technology incident of the financial institution that should also be notified of the updated state of the information technology incident (e.g., user device 306).

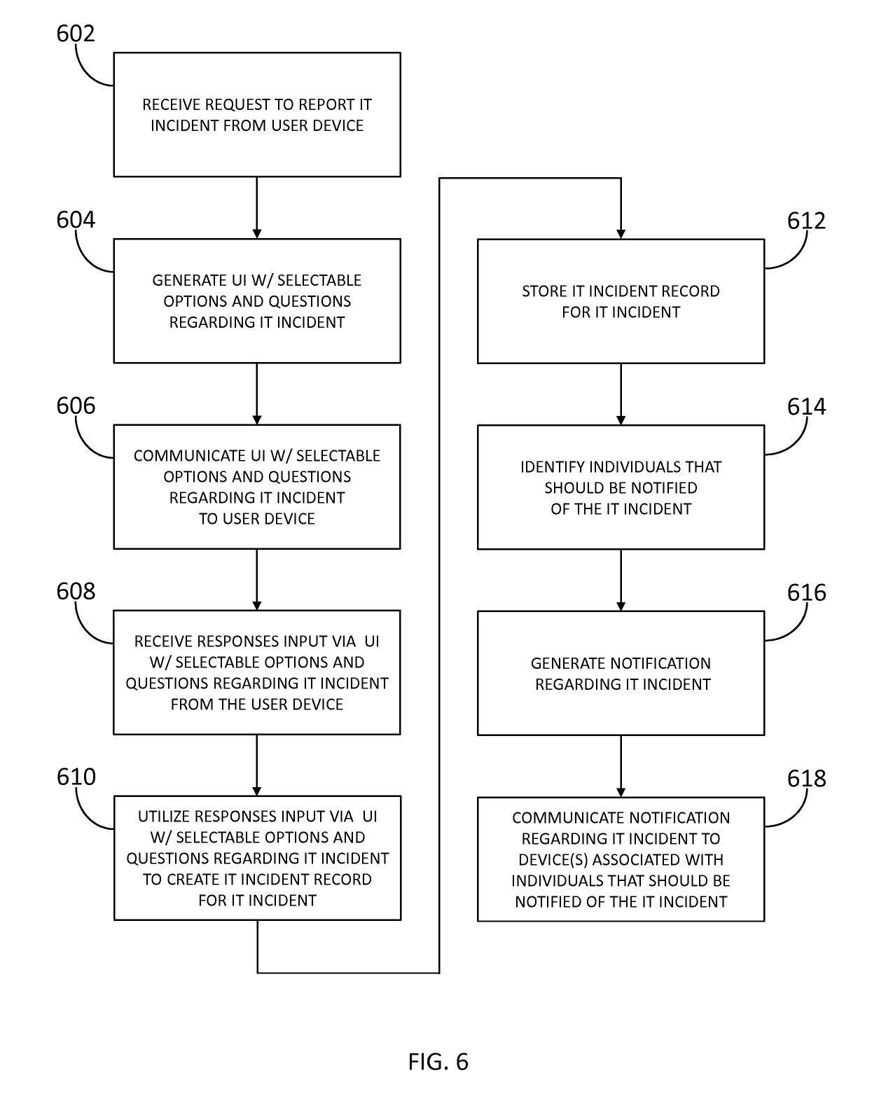

FIG. 6 depicts an illustrative method for information technology incident notification in accordance with one or more example embodiments. Referring to FIG. 6, at step 602, a request to report an information technology incident of a financial institution may be received from a user device. For example, computing platform 310 may receive a request to report an information technology incident of a financial institution from user device 302. At step 604, a user interface comprising a plurality of selectable options and a plurality of questions regarding the information technology incident of the financial institution may be generated. For example, computing platform 310 may generate user interface 500. At step 606, the user interface comprising the plurality of selectable options and the plurality of questions regarding the information technology incident of the financial institution may be communicated to the user device. For example, computing platform 310 may communicate user interface 500 to user device 302. At step 608, a plurality of responses input via the user interface comprising the plurality of selectable options and the plurality of questions regarding the information technology incident of the financial institution may be received from the user device. For example, computing platform 310 may receive a message comprising information identifying the selection of “Line of Business A” and “Initial Incident Report” and user-inputted responses to “Question #1” and “Question #2.” At step 610, the plurality of responses input via the user interface comprising the plurality of selectable options and the plurality of questions regarding the information technology incident of the financial institution may be utilized to create an information technology incident record for the information technology incident of the financial institution. For example, computing platform 310 may utilize the information identifying the selection of “Line of Business A” and “Initial Incident Report” and the user-inputted responses to “Question #1” and “Question #2” to create an information technology incident record for the information technology incident of the financial institution.

At step 612, the information technology incident record for the information technology incident of the financial institution may be stored. For example, computing platform 310 may store the information technology incident record for the information technology incident of the financial institution in memory 316. At step 614, a plurality of individuals associated with the financial institution that should be notified of the information technology incident of the financial institution may be identified. For example, computing platform 310 may identify individuals associated with user devices 304 and 306 as individuals associated with the financial institution that should be notified of the information technology incident of the financial institution. At step 616, a notification regarding the information technology incident of the financial institution may be generated based on the plurality of responses input via the user interface comprising the plurality of selectable options and the plurality of questions regarding the information technology incident of the financial institution. For example, computing platform 310 may generate a notification regarding the information technology incident of the financial institution based on the information identifying the selection of “Line of Business A” and “Initial Incident Report” and the user-inputted responses to “Question #1” and “Question #2.” At step 618, the notification regarding the information technology incident of the financial institution may be communicated to one or more user devices associated with the plurality of individuals associated with the financial institution that should be notified of the information technology incident of the financial institution. For example, computing platform 310 may communicate the notification regarding the information technology incident of the financial institution to user devices 304 and 306.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a memory, and a communication interface:
receiving, via the communication interface and from a user device, a request to report an information technology incident of a financial institution; and
responsive to receiving the request to report the information technology incident of the financial institution:
generating, by the at least one processor, a user interface comprising a plurality of selectable options and a plurality of questions regarding the information technology incident of the financial institution, a first selectable option of the plurality of selectable options comprising a plurality of options corresponding to lines of business of the financial institution, a second selectable option of the plurality of selectable options comprising a plurality of options corresponding to states of the information technology incident of the financial institution, wherein the user interface is configured to, based on a line of business of the financial institution selected using the first selectable option and a state of the information technology incident of the financial institution selected using the second selectable option, display a first portion of the plurality of questions regarding the information technology incident of the financial institution and hide a second portion of the plurality of questions regarding the information technology incident of the financial institution; and
communicate, via the communication interface and to the user device, the user interface comprising the plurality of selectable options and the plurality of questions regarding the information technology incident of the financial institution.

2. The method of claim 1, comprising:
receiving, via the communication interface and from the user device, a plurality of responses input via the user interface comprising the plurality of selectable options and the plurality of questions regarding the information technology incident of the financial institution, each response of the plurality of responses corresponding to a question of the plurality of questions regarding the information technology incident of the financial institution that is in the first portion of the plurality of questions regarding the information technology incident of the financial institution;
utilizing, by the at least one processor, the plurality of responses input via the user interface comprising the plurality of selectable options and the plurality of questions regarding the information technology incident of the financial institution to create an information technology incident record for the information technology incident of the financial institution; and
storing, by the at least one processor and in the memory, the information technology incident record for the information technology incident of the financial institution.

3. The method of claim 2, comprising:
identifying, by the at least one processor and based on the line of business of the financial institution selected using the first selectable option, a plurality of individuals associated with the financial institution that should be notified of the information technology incident of the financial institution;
generating, by the at least one processor and based on the plurality of responses input via the user interface comprising the plurality of selectable options and the plurality of questions regarding the information technology incident of the financial institution, a notification regarding the information technology incident of the financial institution; and
communicating, via the communication interface and to one or more user devices associated with the plurality of individuals associated with the financial institution that should be notified of the information technology incident of the financial institution, the notification regarding the information technology incident of the financial institution.

4. The method of claim 3, wherein generating the notification regarding the information technology incident of the financial institution comprises generating a notification regarding the information technology incident of the financial institution that comprises information indicating the state of the information technology incident of the financial institution selected using the second selectable option.

5. The method of claim 3, wherein generating the notification regarding the information technology incident of the financial institution comprises generating a notification regarding the information technology incident of the financial institution that comprises information from one or more responses of the plurality of responses input via the user interface comprising the plurality of selectable options and the plurality of questions regarding the information technology incident of the financial institution.

6. The method of claim 3, wherein generating the notification regarding the information technology incident of the financial institution comprises:
determining, by the at least one processor and based on the state of the information technology incident of the financial institution selected using the second selectable option, a level of specificity for the notification regarding the information technology incident of the financial institution; and
generating a notification regarding the information technology incident of the financial institution having the level of specificity for the notification regarding the information technology incident of the financial institution.

7. The method of claim 3, wherein identifying the plurality of individuals associated with the financial institution that should be notified of the information technology incident of the financial institution comprises identifying, by the at least one processor and based on the state of the information technology incident of the financial institution selected using the second selectable option, one or more individuals of the plurality of individuals associated with the financial institution that should be notified of the information technology incident of the financial institution.

8. The method of claim 3, wherein identifying the plurality of individuals associated with the financial institution that should be notified of the information technology incident of the financial institution comprises identifying, by the at least one processor and based on information from one or more responses of the plurality of responses input via the user interface comprising the plurality of selectable options and the plurality of questions regarding the information technology incident of the financial institution, one or more individuals of the plurality of individuals associated with the financial institution that should be notified of the information technology incident of the financial institution.

9. The method of claim 3, comprising generating at least one of an email message comprising the notification regarding the information technology incident of the financial institution, a short message service (SMS) message comprising the notification regarding the information technology incident of the financial institution, a multimedia messaging service (MMS) message comprising the notification regarding the information technology incident of the financial institution, or a message comprising the notification regarding the information technology incident of the financial institution that is configured for an information technology incident mobile application of the financial institution, and wherein communicating the notification regarding the information technology incident of the financial institution comprises communicating, to at least one of the one or more user devices associated with the plurality of individuals associated with the financial institution that should be notified of the information technology incident of the financial institution, the at least one of the email message comprising the notification regarding the information technology incident of the financial institution, the SMS message comprising the notification regarding the information technology incident of the financial institution, the MMS message comprising the notification regarding the information technology incident of the financial institution, or the message comprising the notification regarding the information technology incident of the financial institution that is configured for the information technology incident mobile application of the financial institution.

10. The method of claim 3, wherein generating the notification regarding the information technology incident of the financial institution comprises generating a notification regarding the information technology incident of the financial institution that comprises a link to an interface associated with the information technology incident record for the information technology incident of the financial institution.

11. The method of claim 10, comprising:
receiving, via the communication interface and from a user device of the one or more user devices associated with the plurality of individuals associated with the financial institution that should be notified of the information technology incident of the financial institution, a message indicating that the link to the interface associated with the information technology incident record for the information technology incident of the financial institution has been invoked; and
responsive to receiving the message indicating that the link to the interface associated with the information technology incident record for the information technology incident of the financial institution has been invoked:
generating, by the at least one processor, a user interface comprising the state of the information technology incident of the financial institution selected using the second selectable option and a selectable option for updating the state of the information technology incident of the financial institution; and
communicating, via the communication interface and to the user device of the one or more user devices associated with the plurality of individuals associated with the financial institution that should be notified of the information technology incident of the financial institution, the user interface comprising the state of the information technology incident of the financial institution selected using the second selectable option and the selectable option for updating the state of the information technology incident of the financial institution.

12. The method of claim 11, comprising:
receiving, via the communication interface and from the user device of the one or more user devices associated with the plurality of individuals associated with the financial institution that should be notified of the information technology incident of the financial institution, a message comprising information indicating an updated state of the information technology incident of the financial institution selected using the selectable option for updating the state of the information technology incident of the financial institution; and
altering, by the at least one processor, the information technology incident record for the information technology incident of the financial institution to reflect the updated state of the information technology incident of the financial institution selected using the selectable option for updating the state of the information technology incident of the financial institution.

13. The method of claim 12, comprising:
identifying, by the at least one processor and based on the updated state of the information technology incident of the financial institution selected using the selectable option for updating the state of the information technology incident of the financial institution, a portion of the plurality of individuals associated with the financial institution that should be notified of the information technology incident of the financial institution that should also be notified of the updated state of the information technology incident of the financial institution selected using the selectable option for updating the state of the information technology incident of the financial institution;
generating, by the at least one processor, an update notification regarding the information technology incident of the financial institution that comprises the updated state of the information technology incident of the financial institution selected using the selectable option for updating the state of the information technology incident of the financial institution; and
communicating, via the communication interface and to one or more user devices associated with the portion of the plurality of individuals associated with the financial institution that should be notified of the information technology incident of the financial institution that should also be notified of the updated state of the information technology incident of the financial institution selected using the selectable option for updating the state of the information technology incident of the financial institution, the update notification regarding the information technology incident of the financial institution that comprises the updated state of the information technology incident of the financial institution selected using the selectable option for updating the state of the information technology incident of the financial institution.

14. The method of claim 2, comprising utilizing, by the at least one processor, the plurality of responses input via the user interface comprising the plurality of selectable options and the plurality of questions regarding the information technology incident of the financial institution to generate a message comprising information configured for a system of record for information technology incidents of the financial institution, said information configured for the system of record for information technology incidents of the financial institution utilizing a format that differs from a format of said information technology incident record for the information technology incident of the financial institution.

15. An apparatus, comprising:
at least one processor;
a communication interface; and
a memory storing instructions that when executed by the at least one processor cause the apparatus to:
receive, via the communication interface and from a user device, a request to report an information technology incident of a financial institution;
responsive to receiving the request to report the information technology incident of the financial institution:
generate a user interface comprising a plurality of selectable options and a plurality of questions regarding the information technology incident of the financial institution, a first selectable option of the plurality of selectable options comprising a plurality of options corresponding to lines of business of the financial institution, a second selectable option of the plurality of selectable options comprising a plurality of options corresponding to states of the information technology incident of the financial institution, wherein the user interface is configured to, based on a line of business of the financial institution selected using the first selectable option and a state of the information technology incident of the financial institution selected using the second selectable option, display a first portion of the plurality of questions regarding the information technology incident of the financial institution and hide a second portion of the plurality of questions regarding the information technology incident of the financial institution; and
communicate, via the communication interface and to the user device, the user interface comprising the plurality of selectable options and the plurality of questions regarding the information technology incident of the financial institution; and
receive, via the communication interface and from the user device, a plurality of responses input via the user interface comprising the plurality of selectable options and the plurality of questions regarding the information technology incident of the financial institution, each response of the plurality of responses corresponding to a question of the plurality of questions regarding the information technology incident of the financial institution that is in the first portion of the plurality of questions regarding the information technology incident of the financial institution;
utilize the plurality of responses input via the user interface comprising the plurality of selectable options and the plurality of questions regarding the information technology incident of the financial institution to create an information technology incident record for the information technology incident of the financial institution; and
store, in the memory, the information technology incident record for the information technology incident of the financial institution.

16. The apparatus of claim 15, wherein the instructions, when executed by the at least one processor, cause the apparatus to:
identify, based on the line of business of the financial institution selected using the first selectable option, a plurality of individuals associated with the financial institution that should be notified of the information technology incident of the financial institution;
generate, based on the plurality of responses input via the user interface comprising the plurality of selectable options and the plurality of questions regarding the information technology incident of the financial institution, a notification regarding the information technology incident of the financial institution; and
communicate, via the communication interface and to one or more user devices associated with the plurality of individuals associated with the financial institution that should be notified of the information technology incident of the financial institution, the notification regarding the information technology incident of the financial institution.

17. The apparatus of claim 15, wherein the instructions, when executed by the at least one processor, cause the apparatus to utilize the plurality of responses input via the user interface comprising the plurality of selectable options and the plurality of questions regarding the information technology incident of the financial institution to generate a message comprising information configured for a system of record for information technology incidents of the financial institution, said information configured for the system of record for information technology incidents of the financial institution utilizing a format that differs from a format of said information technology incident record for the information technology incident of the financial institution.

18. One or more non-transitory computer-readable media having instructions stored thereon, that when executed by one or more computers, cause the one or more computers to:
generate a user interface comprising a plurality of selectable options and a plurality of questions regarding an information technology incident of a financial institution, a first selectable option of the plurality of selectable options comprising a plurality of options corresponding to lines of business of the financial institution, a second selectable option of the plurality of selectable options comprising a plurality of options corresponding to states of the information technology incident of the financial institution, wherein the user interface is configured to, based on a line of business of the financial institution selected using the first selectable option and a state of the information technology incident of the financial institution selected using the second selectable option, display a first portion of the plurality of questions regarding the information technology incident of the financial institution and hide a second portion of the plurality of questions regarding the information technology incident of the financial institution; and
communicate, to a user device, the user interface comprising the plurality of selectable options and the plurality of questions regarding the information technology incident of the financial institution.

19. The one or more non-transitory computer-readable media of claim 18, wherein the instructions when executed by the one or more computers, cause the one or more computers to:
receive, from the user device, a plurality of responses input via the user interface comprising the plurality of selectable options and the plurality of questions regarding the information technology incident of the financial institution, each response of the plurality of responses corresponding to a question of the plurality of questions regarding the information technology incident of the financial institution that is in the first portion of the plurality of questions regarding the information technology incident of the financial institution;
utilize the plurality of responses input via the user interface comprising the plurality of selectable options and the plurality of questions regarding the information technology incident of the financial institution to create an information technology incident record for the information technology incident of the financial institution; and
store the information technology incident record for the information technology incident of the financial institution.

20. The one or more non-transitory computer-readable media of claim 19, wherein the instructions when executed by the one or more computers, cause the one or more computers to utilize the plurality of responses input via the user interface comprising the plurality of selectable options and the plurality of questions regarding the information technology incident of the financial institution to generate a message comprising information configured for a system of record for information technology incidents of the financial institution, said information configured for the system of record for information technology incidents of the financial institution utilizing a format that differs from a format of said information technology incident record for the information technology incident of the financial institution.
